(19) United States
(12) Patent Application Publication
(10) Pub. No.: US 2026/0280248 A1
(43) Pub. Date: Sep. 17, 2026

(54) AN APPARATUS FOR EXTERIOR ELECTRICAL EXTENSION AND NETWORK CONNECTIVITY

(71) Applicant: Ghonche Goli, RESEDA, CA (US)

(72) Inventor: Ghonche Goli, RESEDA, CA (US)

(21) Appl. No.: 19/680,490

(22) Filed: May 18, 2026

Related U.S. Application Data
(63) Continuation-in-part of application No. 18/808,374, filed on Aug. 19, 2024, now Pat. No. 12,658,563.
(60) Provisional application No. 63/520,905, filed on Aug. 21, 2023.

(51) Int. Cl. H02G 3/08; F21V 23/04; F21W 131/107; H02G 3/18

(52) U.S. Cl. CPC H02G 3/083; F21V 23/0435; H02G 3/18; F21W 2131/107

(57) ABSTRACT

An apparatus for outdoor power supply and internet connectivity that can be mounted to an exterior porch light junction box or independently, receiving alternate power through a grounded interior property outlet. The apparatus includes a housing having a front side and a rear side, wherein the rear side is mounted to the junction box or affixed to an exterior substrate. One or more power conversion modules are encased within the housing for transforming the power supply, such as from 110 V to 24 V. A Wireless communication module is encased within the housing, wherein hybrid antennas of the Wireless communication module and/or LTE and 5G internet are mounted to an outer side of a wall of the housing. A lighting element or other apparatus may be mounted to the front side of the housing. Multiple power sockets are connected to the power supply and the power conversion module, respectively.

### CROSS REFERENCE TO RELATED APPLICATIONS

This application is a continuation-in-part of a U.S. patent application Ser. No. 18/808,374 filed on Aug. 19, 2024, which claims priority from a U.S. Provisional Patent Appl. No. 63/520,905, filed on Aug. 21, 2023, both of which are incorporated herein by reference in their entirety.

### FIELD OF INVENTION

The present invention relates to converting an electrical source of an exterior light junction box into supporting and powering an apparatus to provide exterior and interior Power, a Wireless communication module, and up to five different types of Internet Source Connectivity to multiple exterior and interior electrical and smart IoT devices.

### BACKGROUND

Exterior electrical power access remains limited in many residential, commercial, and multi-unit buildings. A substantial number of structures were constructed without dedicated outdoor receptacles or with an insufficient number of conveniently located exterior power sources. As a result, occupants often encounter difficulty powering electrical devices in outdoor areas.

At the same time, the demand for exterior electrical power continues to increase due to widespread adoption of outdoor electronic products intended to improve convenience, security, communication, maintenance, and entertainment. Such products may include, without limitation, surveillance cameras, video doorbells, lighting systems, landscape equipment, displays, sensors, charging devices, and other smart connected apparatuses.

In the absence of available exterior power outlets, many outdoor devices rely on disposable or rechargeable batteries. Battery-powered operation presents numerous disadvantages, including limited runtime, recurring replacement or recharging requirements, reduced reliability, interruption of service, and lifecycle environmental impacts associated with manufacturing, transportation, and disposal.

Certain exterior devices require a substantially continuous electrical supply to perform intended functions. For example, security cameras, network devices, smart locks, package management systems, sensors, and emergency communication equipment may require persistent power and reliable connectivity. Battery operation may be impractical or inadequate for such applications.

Internet and network connectivity have likewise become increasingly desirable in exterior areas. Users often seek wireless coverage and data connectivity for outdoor workspaces, entertainment areas, security systems, smart appliances, automation controls, and Internet of Things (IoT) devices. Conventional indoor wireless networks frequently provide insufficient signal strength, limited range, or unreliable performance in outdoor environments.

Existing methods for extending electrical power or data connectivity to exterior locations often require permanent modifications to a building, including running new wiring through walls, installing conduit, trenching, adding receptacles, or reconfiguring electrical circuits. Such installations may be costly, time-consuming, aesthetically undesirable, and frequently require licensed professional assistance.

These challenges are particularly significant for renters, tenants, condominium occupants, leaseholders, and commercial operators who may be restricted from making permanent structural or electrical modifications to the property.

Many buildings, however, already include exterior light fixtures mounted to electrical junction boxes supplied by an existing electrical circuit. Such junction boxes are commonly positioned at convenient exterior locations but are generally limited to supporting the installed lighting fixture and do not provide multifunction access to additional electrical power, communications, or network connectivity.

Accordingly, there exists a need for an apparatus capable of utilizing an existing exterior electrical source, such as an exterior light junction box, to provide expanded exterior and/or interior electrical power, communication capability, and multiple forms of network connectivity for one or more connected devices, while reducing installation complexity, cost, and the need for permanent property modifications.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

A principal object of the present invention is to provide an exterior power hub capable of supplying electrical power to a plurality of devices without requiring substantial structural or electrical modifications to an existing building.

Another object of the present invention is to provide an apparatus that is economical to manufacture, install, maintain, and operate.

Another object of the present invention is to provide a multifunction apparatus capable of delivering electrical power, communication capability, and network connectivity through a single integrated unit.

Another object of the present invention is to provide an apparatus configured for installation upon or in connection with an existing exterior light fixture junction box or comparable electrical mounting structure.

Another object of the present invention is to provide an apparatus capable of extending wireless network coverage, including Wi-Fi coverage, to exterior areas of a building or property.

Another object of the present invention is to provide an apparatus configured to power, support, or operate an attached or associated lighting element while simultaneously supplying power to additional devices.

Another object of the present invention is to provide an apparatus that reduces or eliminates reliance on battery-powered exterior devices by supplying continuous electrical power.

Another object of the present invention is to provide an apparatus having an aesthetically pleasing and architecturally compatible exterior appearance suitable for residential and commercial installation.

Another object of the present invention is to provide an apparatus that may be installed with minimal tools, reduced labor, and simplified retrofit procedures.

Another object of the present invention is to provide an apparatus suitable for use by homeowners, tenants, landlords, and commercial users where permanent property alterations may be limited or undesirable.

These and other objects and advantages of the present invention will become apparent from the following description of the preferred embodiments.

In one aspect, disclosed is an apparatus that can use an electrical source of an exterior light junction box for exterior and interior Power, use as a Wireless communication module, and connect up to four different types of Internet Source Connectivity to multiple exterior and interior electrical and smart IoT devices.

In one aspect, disclosed is an apparatus that can also be plugged into an interior electrical outlet in case no exterior junction box exists, by drilling an access hole in an exterior wall, to place the apparatus in a position to be connected to specific lighting, safety, and security devices desired for use in residential and commercial properties.

In one aspect, the apparatus may allow connectivity of up to four different Internet Sources, from Cellular based Internet, hardwired Ethernet, Satellite Internet, and Fiber-Optic Internet, are possible through specifically designed exterior connectivity ports that allow for each Internet Source Provider.

In one aspect, the disclosed apparatus provides hardwired electrical, Internet, and Wi-Fi connectivity to a variety of electronic components and eliminates the use of battery-operated devices.

In one aspect, disclosed is an apparatus for outdoor power supply and internet connectivity, the apparatus comprising a housing having a front side and a rear side, wherein the rear side is mounted to the junction box, the rear side has an opening for receiving wires from the junction box for a main power supply; one or more power conversion modules encased within the housing for transforming the main power supply; and a Wireless communication module encased within the housing, wherein antennas of the Wireless communication module are mounted to an outer side of a wall of the housing. The apparatus further comprises a lighting element mounted to the front side of the housing. The apparatus further comprises one or more power sockets configured in the wall of the housing.

In one aspect, the one or more power sockets comprise two to four power sockets, wherein one of the two to four power sockets is connected to the main power supply, and a second power socket of the two to four power sockets is connected to one of the one or more power conversion modules.

In one aspect, the power conversion module is configured to transform a 110 V power supply to a 24V power supply.

In one aspect, the housing has venting slots configured in the wall for dissipating heat.

In one aspect, the apparatus further comprises a light sensor; a motion sensor; and a switch connected to the light sensor and the motion sensor for switching between the light sensor and the motion sensor. The light sensor and the motion sensor are mounted in a sensor casing, wherein the sensor casing is mounted to the housing through a shaft and a rotatable joint.

In one aspect, the apparatus further comprises a mesh Wi-Fi Repeater.

In one aspect, disclosed is a method for outdoor power supply and internet connectivity, the method comprising removing an lighting element from a junction box; and mounting an apparatus over the junction box. The apparatus comprises a housing having a front side and a rear side, wherein the rear side is mounted to the junction box, the rear side has an opening for receiving wires from the junction box for a main power supply, one or more power conversion modules encased within the housing for transforming the main power supply, and a Wireless communication module encased within the housing, wherein antennas of the Wireless communication module are mounted to an outer side of a wall of the housing.

In one aspect, the apparatus further comprises four separate 1.0 Gigabit and one 2.5 Gigabit Ethernet port positioned on a top of the housing for LTE and 5G external internet source connectivity; hybrid 5 GHz and 2.4 GHz spectrum hybrid antennas; an integrated Cellular Module internet source connected to the hybrid 5 GHz and 2.4 GHz spectrum hybrid antennas; a Fiber-Optic internet female plug; and a Satellite internet female plug.

In one aspect, the lighting element may be a porch light, a Decorative light, a security light, or any exterior illumination fixture.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the apparatus including a lighting element mounted thereto, according to an exemplary embodiment of the present invention.

FIG. 2 is a perspective view of the apparatus illustrating a plurality of alternative power socket configurations, according to an exemplary embodiment of the present invention.

FIG. 3 is a perspective view of a housing of the apparatus, according to an exemplary embodiment of the present invention.

FIG. 4 is an environmental view showing the apparatus mounted to an exterior wall and supporting a lighting element, according to an exemplary embodiment of the present invention.

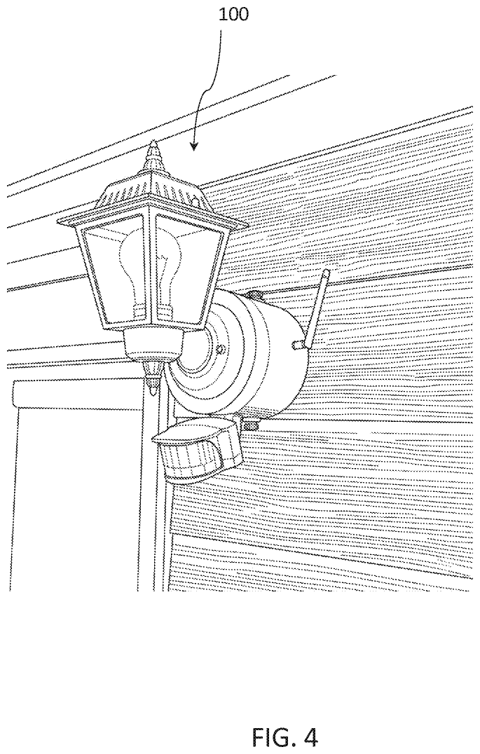

FIG. 5 is a schematic block diagram illustrating an exemplary controller architecture of the apparatus, according to an exemplary embodiment of the present invention.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The present invention relates to an apparatus configured for exterior use and including a power hub adapted to supply electrical power to a plurality of exterior electronic devices. In certain embodiments, the apparatus further includes or supports a lighting element. The apparatus may additionally include a wireless communication module configured to provide exterior wireless network coverage.

The apparatus may be mounted to an exterior surface of a building, including without limitation a residential structure, commercial building, public facility, multi-unit dwelling, or similar property. The apparatus may be electrically coupled to an existing building power supply and hardwired thereto. In one exemplary embodiment, the apparatus is installed in connection with an exterior electrical junction box previously used for a porch light or other exterior lighting fixture. The apparatus may also be installed at other exterior electrical junctions, switch locations, fixture mounts, or comparable powered mounting points. Once installed, the apparatus provides a plurality of connection options for powering or interfacing with electrical devices, including smart devices and Internet of Things (IoT) devices.

In preferred embodiments, the apparatus is configured to present a clean and aesthetically integrated appearance with concealed or minimized exposed wiring. The apparatus thereby reduces clutter commonly associated with extension cords, adapters, and externally routed conductors. The apparatus further reduces or eliminates the need to route temporary electrical cords through doors, windows, openings, or other passageways. Such conventional practices may create safety hazards including cord pinching, insulation damage, conductor exposure, tripping hazards, electrical shock risk, and short-circuit conditions within the building electrical system.

The apparatus addresses longstanding deficiencies associated with powering exterior electronic devices and providing reliable exterior network connectivity. In particular, the apparatus may provide direct electrical power, Power over Ethernet (PoE), and wireless communication capability to support a wide variety of connected devices without reliance upon battery-powered operation.

By utilizing an available building electrical source, the disclosed apparatus may supply selected voltages, current capacities, and communication interfaces sufficient to operate one or more integrated electronic devices, peripherals, sensors, and smart technologies. The apparatus may further distribute power and data to connected equipment through wired and wireless pathways.

In certain embodiments, the apparatus functions as an exterior gateway platform adapted to support security systems, cameras, access controls, lighting systems, delivery management devices, emergency communication equipment, environmental sensors, automation systems, and other residential or commercial technologies. Through such capabilities, the apparatus may improve safety, convenience, operational efficiency, connectivity, and property security while reducing maintenance associated with battery replacement, temporary wiring, and fragmented standalone devices.

Disclosed herein is an electrical power and network junction box extension apparatus configured to support a lighting element and a plurality of additional electrical and communication devices, together with methods for supplying power and connectivity to such devices. The apparatus may be adapted to support wired and wireless electronic equipment, including smart devices, Internet of Things (IoT) devices, sensors, cameras, controllers, access devices, communication modules, and related peripherals. The apparatus may further provide one or more electrical output interfaces and one or more network source interfaces for selectively powering, connecting, and operating supported devices from an existing building electrical source.

The electrical apparatus may be powered directly from an existing electrical supply of the building and electrically coupled thereto through suitable connectors, terminals, adapters, or wiring interfaces. The building may comprise a residential dwelling, apartment unit, condominium, commercial structure, office, retail facility, public building, or other occupied premises.

In preferred embodiments, the apparatus is configured for simplified installation using a retrofit or plug-and-play arrangement adapted to mate with existing exterior electrical infrastructure, thereby reducing installation complexity and minimizing the need for substantial structural modification. By utilizing existing building power sources and convenient connection methods, the apparatus enables efficient deployment of exterior lighting, smart devices, communication modules, security systems, sensors, and other powered equipment.

In certain embodiments, the apparatus includes an extension housing sized and shaped to correspond with conventional electrical junction box formats, including cylindrical, square, rectangular, or other standardized residential or commercial configurations. The extension housing may be configured to mount over, replace, or interface with an existing junction box positioned within a wall, ceiling, soffit, eave, or other structural surface, while providing additional internal space for electrical components, communication modules, connectors, and device interfaces. In preferred implementations, the apparatus is adapted to utilize an existing hardwired electrical source that previously supported an exterior or interior lighting fixture, thereby converting the location into a multifunction power and connectivity hub.

Conventional extension cords are often impractical or unsafe for supplying exterior power from an interior source because cords may need to pass through a doorway, window, or similar opening lacking adequate clearance or environmental sealing. Such practices may result in pinching, abrasion, cutting, insulation damage, conductor exposure, tripping hazards, electrical shock risk, short-circuit conditions, moisture intrusion, energy loss, or compromise of building security caused by partially open doors or unlocked windows. By contrast, the disclosed apparatus provides a safer and more permanent alternative by utilizing an existing junction box location to deliver exterior power and connectivity without the need for temporary cord routing.

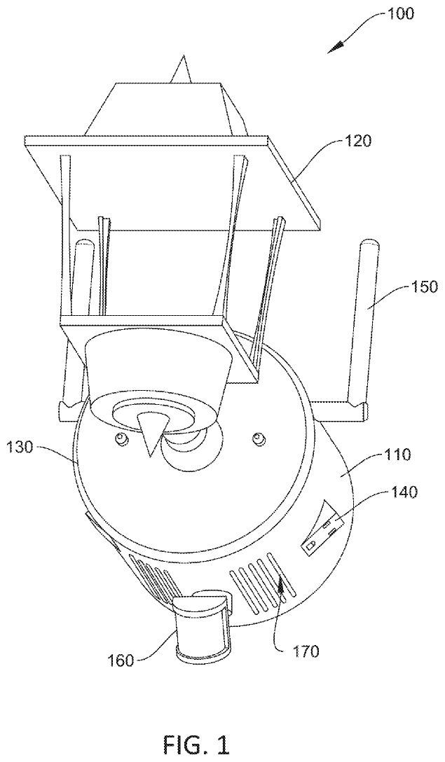

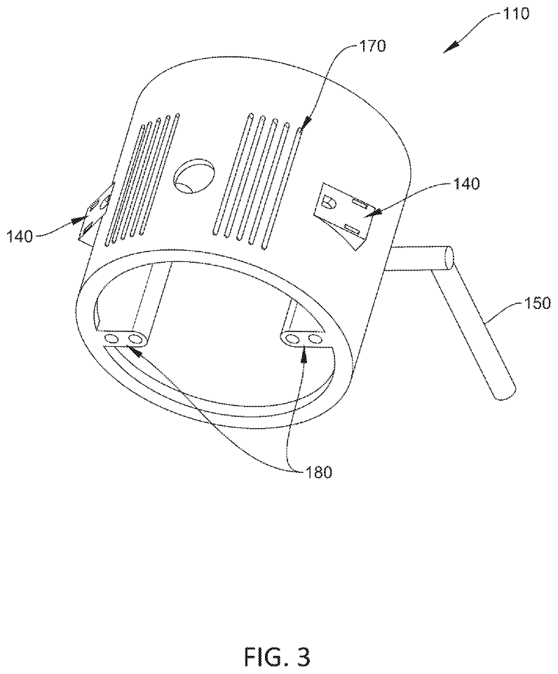

Referring to FIG. 1, an exemplary embodiment of apparatus 100 is illustrated in perspective view. Apparatus 100 includes a housing 110 configured to enclose and protect the internal components of the apparatus. In the illustrated embodiment, housing 110 has a generally cylindrical hollow profile including a front side and a rear side. Housing 110 is shown in greater detail in FIG. 3. It shall be understood, however, that the depicted configuration is exemplary only and not limiting. Apparatus 100 may be mounted to a supporting structure, such as an exterior wall, interior wall, ceiling, soffit, post, column, or similar surface, with the rear side of housing 110 positioned adjacent the supporting structure.

In certain embodiments, the rear side of housing 110 includes a flange, bracket, mounting ring, or equivalent attachment structure having one or more apertures sized to receive screws, bolts, anchors, or other fasteners for securing apparatus 100 to the supporting structure. The rear side may further define one or more openings, knockouts, ports, or pass-through regions configured to receive electrical conductors, communication cables, grounding members, or related connectors extending from an existing junction box or other power source.

In the embodiment shown in FIG. 3, the rear portion of housing 110 may be open or recessed to align with an existing junction box cavity. In alternative embodiments, the rear side may include a cover plate, back plate, gasketed panel, or sealed enclosure member. Any plate, opening, conduit interface, or cable passage may include seals, grommets, bushings, gaskets, membranes, or weather-resistant barriers configured to reduce or prevent ingress of moisture, dust, insects, debris, and other environmental contaminants into housing 110.

Although housing 110 is illustrated as generally cylindrical, the housing may alternatively be circular, polygonal, oval, rectangular, square, low-profile, faceted, or otherwise contoured without departing from the spirit and scope of the present invention. Housing 110 may be formed from metal, polymeric material, composite material, corrosion-resistant alloy, or combinations thereof, and may be configured for exterior exposure under varying environmental conditions.

The front side of housing 110 may be configured to support a lighting element, such as porch light 120, wall light, sconce, security light, decorative fixture, pathway light, or other illumination device. In certain embodiments, apparatus 100 is configured to replace an existing exterior porch light assembly while utilizing the preexisting electrical junction box and power source associated therewith. A mounting plate 130 associated with porch light 120 or another lighting fixture may cover, partially cover, or interface with the front opening of housing 110, thereby contributing to enclosure integrity and aesthetic appearance.

Preferably, the housing and associated interfaces are weather resistant. Openings, seams, ports, cable passages, and fixture interfaces may be sealed through gaskets, O-rings, sealants, compression fittings, membranes, or equivalent moisture-resistant structures to reduce or prevent water ingress. In one embodiment, the rear side of housing 110 includes a peripheral flange adapted to receive a foam, rubber, elastomeric, or compressible weather gasket configured to seal against an exterior mounting surface and reduce seepage or intrusion of water. Such gasket arrangements may conform to irregular or textured exterior surfaces including stucco, siding, masonry, brick, stone, concrete, wood, metal cladding, or composite building materials. The front side of housing 110 may likewise include one or more sealing members positioned between the housing and lighting element 120, mounting plate 130, access cover, or front panel.

Housing 110 may further include flange 180, bracketry, threaded interface, rails, bosses, or mounting structures configured to secure the lighting element to the housing. In certain embodiments, flange 180 extends along at least a portion of the length or perimeter of housing 110 to provide structural support, alignment, and attachment capability for the lighting element or other accessory components.

The apparatus may include one or more electrical connectors configured to couple with conductors extending from an existing building junction box, such as a junction box previously supporting a porch light or other fixture. In typical implementations, the connector assembly may include terminations for line, neutral, and ground conductors corresponding to the building electrical supply. Additional terminals may be provided for switched line conductors, low-voltage conductors, communication wiring, or auxiliary circuits.

The apparatus may further include a power conditioning unit configured to receive input power from the building electrical system and provide regulated, converted, filtered, or distributed output power for internal and external loads. The power conditioning unit may include one or more power conversion modules adapted to convert an input voltage to one or more selected output voltages, current levels, or power formats suitable for connected devices. In certain embodiments, the power conditioning unit performs alternating current (AC) to direct current (DC) conversion for powering low-voltage electronics, communication modules, sensors, lighting devices, controllers, or smart devices.

The power conditioning unit may additionally include surge suppression, transient voltage protection, overcurrent protection, short-circuit protection, thermal protection, ground fault protection, filtering circuitry, and related protective features to reduce risk of damage to connected components. By way of example and without limitation, the apparatus may include a 24-volt conversion module. Other embodiments may provide 5 V, 12 V, 24 V, 48 V, USB-standard outputs, PoE-compatible outputs, line-voltage pass-through, or combinations thereof. The power conditioning unit may be implemented using transformers, switched-mode power supplies, rectifiers, regulators, inverters, relays, breakers, fuses, printed circuit assemblies, or combinations thereof.

In certain embodiments, the apparatus includes hardwired input conductors configured to receive electrical power from an existing property junction box, electrical fixture box, or branch circuit. The input conductors may include line, neutral, and ground connections, and may optionally include switched line conductors or additional auxiliary conductors depending upon the installation environment. The received input power may be routed through prewired internal circuitry of the apparatus to one or more power conversion modules, including a built-in 24-volt conversion module. The 24-volt conversion module may transform incoming building supply power into a regulated 24 V output suitable for operating compatible electronic devices. The converted 24 V output may be delivered to one or more dedicated output ports, terminals, sockets, jacks, or female connector interfaces integrated into the apparatus.

In certain embodiments, the female connector interface is keyed, proprietary, standardized, weather-resistant, locking, or otherwise configured for selective connection to corresponding powered accessories or devices. The 24 V output may be used to power exterior or interior devices including cameras, sensors, smart locks, access controls, controllers, relays, communication modules, low-voltage lighting, package management devices, automation systems, and other 24 V electronic equipment. In preferred implementations, the apparatus may simultaneously provide line-voltage outputs, low-voltage outputs, and network connectivity interfaces from a common installation point.

Referring again to FIG. 1, apparatus 100 may include one or more power sockets 140 configured for electrical connection to external electronic devices. A plurality of power sockets 140 may be provided to permit simultaneous powering of multiple devices from the apparatus. In certain embodiments, the power sockets 140 are positioned on a wall, face, side surface, front panel, lower panel, or other accessible region of housing 110. The power sockets 140 may comprise receptacles, jacks, terminals, ports, plug interfaces, USB interfaces, locking connectors, weather-resistant outlets, or other electrical connection structures. Different socket types may be provided to supply different voltage levels, current ratings, or power standards according to the intended connected device.

By way of example and without limitation, one or more 24-volt sockets may be electrically coupled to the 24 V power conversion module for powering compatible low-voltage devices. One or more line-voltage sockets, such as 110 V, 120 V, 220 V, or 240 V receptacles depending upon regional standards, may be provided for powering conventional appliances or equipment. One or more 12-volt output sockets may likewise be included for powering 12 V devices including lighting systems, sensors, communication devices, automotive-style accessories, and control equipment.

In further embodiments, the apparatus may simultaneously provide multiple voltage outputs through isolated or independently protected circuits. Each socket may include protective features such as covers, shutters, ground fault protection, overcurrent protection, weather seals, tamper resistance, surge protection, indicator lights, or switching controls.

Information relating to voltage, current rating, polarity, intended use, safety warnings, or connector type may be positioned adjacent the respective sockets as labels, markings, embossments, printed indicia, illuminated indicators, or other identification means. To reduce the possibility of improper connection, the sockets may be configured to receive only corresponding compatible plugs or mating connectors. For example, a 24-volt power socket may include a keyed geometry, unique pin arrangement, locking interface, dimensional profile, or proprietary connector format that prevents insertion into a line-voltage socket such as a 110 V or 120 V receptacle. Likewise, line-voltage sockets may be physically differentiated from low-voltage sockets to minimize accidental cross-connection and associated equipment damage or safety hazards.

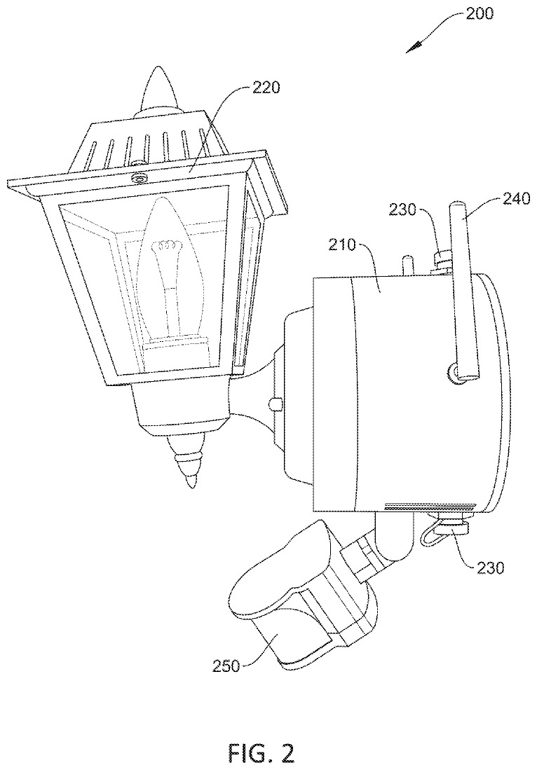

In certain embodiments, the sockets and associated plugs are weather-resistant or waterproof and suitable for exterior installation, as generally illustrated in FIG. 2. Protective features may include sealed connector housings, gasketed covers, compression seals, O-rings, drain paths, corrosion-resistant contacts, tethered caps, and moisture barriers. Color coding, symbols, tactile markings, shapes, or illuminated indicators may additionally be used to distinguish voltage classes, connector functions, or device compatibility and thereby reduce mismatch. Where the apparatus includes an internal power conversion module, such as a 24 V conversion module, housing 110 may include venting slots 170, louvers, heat-dissipation channels, heat sinks, thermal pads, or convection pathways to facilitate removal of heat generated during operation. In preferred embodiments, venting structures are positioned to promote airflow while maintaining resistance to water ingress, debris intrusion, and insect entry.

In certain embodiments, one or more sockets are provided with protective covers configured to shield the sockets from weather, debris, insects, and contamination when not in use. The protective covers may be hinged, removable, sliding, snap-fit, threaded, gasketed, or otherwise movably attached to housing 110. In some implementations, the covers are retained by lanyards, tethers, flexible straps, hinge members, or captive attachment structures to reduce the likelihood of loss or separation from the apparatus.

One or more line-voltage sockets, such as 110 V or 120 V receptacles, may be protected by a ground-fault interrupter (GFI) or ground-fault circuit interrupter (GFCI) device rated for exterior use. The GFI/GFCI protective device may include test and reset switches positioned on a face portion, access panel, or other user-accessible region of the apparatus.

In certain embodiments, a cover plate may be removably secured to the housing, such as by screws, quarter-turn fasteners, latches, or locking members, to function as a port cover for connected cords or cables. The cover plate may define one or more access openings sized to receive extension cords, power leads, data cables, or connector bodies while maintaining partial enclosure of the connected interface. In preferred embodiments, the access openings are sized or shaped to retain connected male plugs or connector ends in a stable manner so as to reduce accidental disengagement caused by pulling, vibration, weather, or movement. The cover plate may further deter unauthorized disconnection, tampering, or unintended removal of connected devices. Seals, gaskets, compression members, or flexible membranes may be associated with the cover plate to maintain weather resistance while cords or cables remain connected.

The apparatus may further include network circuitry configured to establish, route, repeat, convert, distribute, or enhance one or more communication networks for connected devices. In certain embodiments, the network circuitry functions to extend the coverage of an existing local network. For example, wireless coverage such as Wi-Fi may be expanded to exterior areas surrounding the building. The network circuitry may include one or more routers, repeaters, extenders, switches, gateways, modems, transceivers, signal boosters, controllers, or protocol conversion modules.

In some implementations, the apparatus includes a cellular communication module configured to communicate with indoor equipment, exterior equipment, or directly with a cellular service network. Supported communication sources or protocols may include, without limitation, Wi-Fi, Ethernet, Power over Ethernet (PoE), RS232, RS485, coaxial data systems, cellular data networks, satellite internet systems, fiber-optic internet systems, Bluetooth, Zigbee, Z-Wave, Thread, or other wired or wireless communication standards

The apparatus may further include one or more antennas 150 mounted to or coupled with housing 110. As illustrated in FIG. 1, antennas 150 may be positioned on opposite sides of the housing, although any number, orientation, or placement may be utilized. In certain embodiments, housing 110 includes one or more dedicated female receptacles, ports, jacks, couplers, or interface connectors corresponding to particular network sources or service types. Such interfaces may be positioned on an upper portion of the housing, a molded extension region, side panel, or other installer-accessible location to facilitate connection of external communication sources.

In preferred embodiments, cables entering the apparatus may be routed through angled passages, including approximately 90-degree pathways, conduits, glands, or cable guides to transition through a wall or other structural surface while reducing bend stress and preserving enclosure integrity. The connected source may then be distributed to interior and/or exterior devices through appropriate media including Ethernet cable, fiber-optic cable, PoE cable, coaxial cable, low-voltage wiring, or other transmission pathways.

Protective cable jackets, fire-resistant sheathing, water-resistant conduits, armored coverings, composite jackets, or other environmental protection structures may be employed where required by installation conditions or applicable codes. The housing may include sufficient internal and external clearance to allow installers convenient access for connecting selected internet service sources, network cables, and communication components during installation or servicing.

A properly sized Cord Cover (with Alien-type tape backing and small screw holes) extending from the connectivity point up the Exterior Wall can keep the Internet Source cables neat, secure, and tidy, while a “Rubber Boot” that connects at the bottom of the Cord Cover and extends overall (four potential) Internet Supply Cables at the top elevation of the housing and protects them from water intrusion, ice, dust, insects, etc., is necessary and will make for a clean completed installation.

The apparatus may further include one or more sensors configured to automate operation of the lighting element and/or other connected functions. In certain embodiments, the sensors include a light sensor adapted to detect ambient light conditions, including dawn, dusk, nighttime, daylight, or changing illumination levels, whereby the lighting element may be automatically activated or deactivated. In certain embodiments, the sensors include a motion sensor configured to detect movement, presence, occupancy, or activity within a monitored area proximate the apparatus. Upon detection of motion, the apparatus may activate the lighting element for a predetermined time interval, adjustable duration, or programmable operating cycle. More than one sensor type may be included, and the apparatus may permit user selection between sensor modes, simultaneous sensor operation, prioritized operation, or programmable automation routines. A switch, selector, software setting, mobile application interface, or control input may be provided for selecting between available sensor types or operating modes.

In some embodiments, operation of the lighting element is controlled by the selected sensor input, a combination of sensor inputs, manual override commands, scheduled timers, or remote network commands. As generally illustrated in FIG. 1, one or more sensors 160 may be mounted to a lower portion of housing 110 through a shaft, arm, pivot member, or articulated support. A rotatable joint, swivel joint, ball joint, hinge, or adjustable bracket may be provided to permit directional adjustment of the sensors relative to the apparatus and surrounding monitored area. The sensors 160 may be enclosed within a sensor casing configured to be weather-resistant, waterproof, dust-resistant, impact-resistant, and suitable for prolonged exterior use.

The apparatus may be manufactured, finished, or assembled in a variety of colors, surface treatments, textures, sizes, and decorative designs to enhance aesthetic appearance and compatibility with surrounding architecture. In certain embodiments, users may select from multiple exterior styles, profiles, trim configurations, lens designs, cover shapes, or ornamental features according to personal preference or installation environment. Available finishes may include matte, gloss, metallic, brushed, powder-coated, painted, anodized, plated, woodgrain, stone-look, or custom decorative finishes. The apparatus may be configured to visually coordinate with residential, commercial, industrial, historic, or contemporary building styles, thereby improving acceptance and appearance after installation. Interchangeable exterior covers, bezels, faceplates, trim rings, or accessory panels may also be provided to permit post-installation customization or replacement.

In certain embodiments, the apparatus includes an integrated mesh Wi-Fi repeater, wireless access point, or network extender configured to improve and expand wireless network coverage in exterior areas surrounding the installation site. The mesh Wi-Fi functionality may communicate with an existing indoor router, gateway, modem, or compatible mesh node to provide seamless network extension between interior and exterior environments.

In some implementations, an external camera may be mounted to housing 110 or to an accessory bracket coupled thereto. The camera may comprise a security camera, monitoring camera, door-area camera, package surveillance camera, occupancy camera, or other imaging device configured for exterior operation. In certain embodiments, the camera supports live streaming, remote viewing, event recording, motion-triggered capture, object detection, person detection, vehicle detection, package detection, and machine-learning-assisted tracking of objects or movement. The camera may be electrically coupled directly to one or more side power ports of the apparatus.

In one embodiment, the camera utilizes a multi-pin connector, such as proprietary five-pin power and/or data plug, configured to provide secure electrical and communication coupling. The connector interface may form a weather-resistant or weather-tight seal when engaged with the corresponding port to protect against moisture intrusion during outdoor use. One or more security screws, tamper-resistant fasteners, locking collars, keyed latches, or retention members may be used to secure the camera and/or connector against accidental removal, unauthorized disconnection, or theft. In further embodiments, the apparatus may provide simultaneous power, data backhaul, and network connectivity to the mounted camera through a common connector interface.

In certain embodiments, the apparatus includes one or more proprietary multi-pin connector interfaces, such as five-pin connectors, together with corresponding mating plugs adapted for delivery of 24 V power, line-voltage power, or combinations of power and communication signals. Either or both of the 24 V and line-voltage supplies may be selectively provided through the connector interfaces depending upon the configured port, connected accessory, regional electrical standard, or internal switching arrangement.

In one implementation, a plurality of separate power ports are positioned around side portions of the apparatus, such as up to four side-mounted ports, each configured to receive a mating plug in a plug-and-play manner. Upon removal or opening of a side cover, the mating male plug may be inserted into the corresponding female connector to establish electrical coupling. In preferred embodiments, insertion of the plug automatically engages a weather-resistant or weather-tight sealing structure including gaskets, O-rings, compression seals, locking collars, threaded couplers, or equivalent sealing members. The connector system enables convenient exterior power distribution to a wide variety of electrical devices, accessories, and smart Internet of Things (IoT) components.

In certain embodiments, the mating plug is coupled to an extension cord, accessory cable, device lead, or integrated device harness terminating in pin arrangements corresponding to the intended supply type. Distinct pinouts, keyed geometries, labels, color coding, shapes, markings, electronic identification, or mechanical incompatibility features may be used to distinguish 24 V connectors from line-voltage connectors and thereby reduce improper connection. Devices, accessories, and smart IoT components may be manufactured or adapted to include corresponding multi-pin connectors configured to directly receive power and/or communication services from the apparatus. In further embodiments, the connector interfaces may simultaneously convey electrical power, control signals, sensor data, network communications, or device-status information through selected pins of the multi-pin connector system.

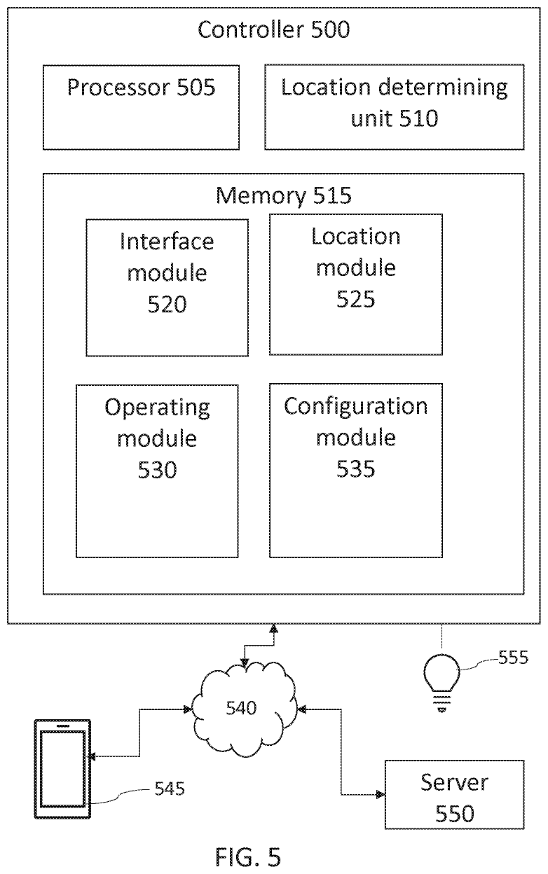

The disclosed apparatus may further include a controller 500, also referred to herein as a control system, configured to manage electrical, lighting, communication, sensing, security, and network-related operations of the apparatus. An exemplary controller architecture is illustrated in FIG. 5. In certain embodiments, controller 500 includes a processor 505, a location-determining unit 510 operably coupled to the processor, and a memory 515 operably coupled to the processor. Processor 505 may include one or more microprocessors, microcontrollers, logic circuits, programmable devices, application-specific integrated circuits (ASICs), field programmable gate arrays (FPGAs), or equivalent processing circuitry configured to execute instructions. Memory 515 may include volatile memory, non-volatile memory, flash memory, EEPROM, RAM, ROM, removable storage, cloud-linked storage, or combinations thereof. The memory stores instructions, settings, profiles, logs, and software modules executable by processor 505.

In certain embodiments, memory 515 includes an interface module 520 configured to generate a user interface on an external user device, allowing a user to monitor and control apparatus functions. Memory 515 may further include a location module 525 configured to determine or process geographic coordinates, address data, geofence parameters, or mapping associations. Memory 515 may also include an operating module 530 configured to execute control logic associated with lighting, power outputs, communications, device interaction, automation routines, and exchanges with external devices or servers. A configuration module 535 may be provided for receiving, storing, and applying user settings, schedules, permissions, rules, network credentials, and device preferences.

As used herein, the term “module” may refer to software, firmware, hardware logic, executable code, scripts, rule sets, or combinations thereof that perform one or more functions when executed or implemented. Operations described herein may be executed sequentially, concurrently, in distributed fashion, locally, remotely, or through multiple processors without departing from the scope of the invention.

Controller 500 may communicate through one or more networks 540 with a user device 545. User device 545 may include a smartphone, tablet, desktop computer, laptop computer, workstation, wearable device, vehicle interface, smart display, or similar computing platform. Network 540 may comprise one or more wired or wireless communication networks including LAN, WAN, WLAN, MAN, VPN, cellular data networks, Bluetooth networks, mesh networks, satellite networks, or the Internet. Multiple networks may be used simultaneously or selectively. For example, a user device may communicate locally through Wi-Fi while also communicating through the Internet or cellular data services.

Controller 500 may further communicate with one or more external servers, including cloud servers, authentication servers, mapping servers, storage servers, analytics servers, or distributed computing systems. One or more control functions described herein may be performed locally at the apparatus, on a user device, at remote servers, or in hybrid distributed form.

The interface generated by interface module 520 may include screens, dashboards, configuration pages, alerts, live camera views, automation settings, power controls, mapping tools, usage statistics, firmware management, and user account features. The interface may be provided through mobile applications, desktop applications, web portals, browser interfaces, APIs, or third-party smart-home platforms. In certain embodiments, applications may be compatible with Android™, iOS™, Windows™, Linux™, macOS™, or other computing environments.

Location-determining unit 510 may include GPS, GNSS, satellite receivers, cellular triangulation systems, Wi-Fi positioning systems, Bluetooth® positioning, or network-assisted location technologies. Geographic coordinates associated with the installed apparatus may be determined and linked with a physical property address, parcel, entrance point, delivery point, gate, or access location. In certain embodiments, mapping data associated with the apparatus may be updated automatically, including digital map markers, property access points, route guidance points, emergency access references, or delivery navigation indicators.

The apparatus may further include a lighting beacon and/or RGB LED lighting element 555 controllable by controller 500. Controller 500 may activate, flash, dim, brighten, pulse, or change colors of the beacon or RGB LED element in response to predefined events, schedules, alerts, arrivals, commands, or automation triggers.

A user may configure through the interface one or more geofences defining selected distances or zones relative to the apparatus. When an approaching electronic device enters a defined geofence, controller 500 may receive a corresponding signal and activate a visual indicator, such as flashing the beacon or RGB LED element. Such signaling may assist visitors, couriers, emergency responders, rideshare operators, guests, or authorized users in identifying the correct property location. In certain embodiments, signaling patterns may vary according to proximity, user identity, delivery status, urgency level, trusted-party status, or programmable rules. Controller 500 may further operate RGB lighting to generate programmable visual patterns, branded color schemes, holiday themes, status indications, warnings, occupancy indicators, or trusted-user recognition signals.

During setup, a user may register the apparatus with a service provider or network server and associate the apparatus with address data, ownership credentials, network credentials, and location coordinates. The apparatus may communicate such information to authorized servers for account management, mapping integration, automation services, fleet delivery coordination, or security services.

In certain embodiments, servers may manage geofences, monitor authorized device approach or departure, synchronize settings, or provide remote notifications. Controller 500 may include network circuitry supporting Bluetooth®, Wi-Fi, Ethernet, mesh protocols, IoT communication standards, and encrypted communications with external devices or servers. Security features may include authentication, encryption, secure boot, token exchange, firewall functions, intrusion detection, permission management, and protection against unauthorized access.

User profiles may be stored locally, remotely, or both, allowing transfer of settings, rules, schedules, permissions, and preferences to replacement apparatuses or multiple apparatus installations. Accordingly, an apparatus may be replaced, reset, or expanded with reduced need for manual reconfiguration.

In certain embodiments, controller 500 may further support smart or AI-enabled camera analytics including motion classification, facial recognition where permitted, object detection, package recognition, license plate detection, anomaly detection, and event prioritization.

In certain embodiments, the apparatus may further comprise a programmable digital backlit address light integrated into the housing and controllable through controller 500. Components described herein may be integrated within a common housing or may operate as distributed coordinated components while maintaining functional integration with the junction-box-mounted apparatus.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for outdoor power supply and network connectivity, the apparatus comprising:
a housing configured to mount to an electrical junction box associated with a building, a rear side of the housing defining one or more openings for receiving wires from the electrical junction box supplying main electrical power;
at least one power conversion module disposed within the housing and configured to transform the main electrical power into one or more different power outputs; and
a wireless communication module disposed within the housing.

2. The apparatus of claim 1, wherein one or more antennas associated with the wireless communication module are mounted to an outer side wall of the housing.

3. The apparatus of claim 1, further comprising a lighting element mounted to a front side of the housing.

4. The apparatus of claim 3, wherein the lighting element comprises a porch light, wall light, security light, decorative light, or LED lighting assembly.

5. The apparatus of claim 1, further comprising one or more exterior-accessible power sockets positioned in a wall of the housing.

6. The apparatus of claim 5, wherein the one or more exterior-accessible power sockets comprise two to four power sockets, wherein a first power socket is connected to the main electrical power and a second power socket is connected to one of the at least one power conversion modules.

7. The apparatus of claim 1, wherein the at least one power conversion module is configured to transform a first voltage power supply into a second voltage power supply, wherein the first voltage differs from the second voltage.

8. The apparatus of claim 1, wherein the wireless communication module comprises a mesh Wi-Fi repeater.

9. The apparatus of claim 1, further comprising a plurality of data ports positioned on an upper portion of the housing for receiving external internet service sources.

10. The apparatus of claim 1, further comprising a controller including a processor and memory storing instructions for controlling operations of the apparatus, wherein the controller is configured to control one or more of lighting functions, power outputs, network settings, security features, automation routines, and notifications.

11. The apparatus of claim 10, further comprising a location-determining unit configured to determine geographic coordinates of the apparatus, wherein the controller is configured to associate the geographic coordinates with a property address.

12. The apparatus of claim 11, wherein the controller is configured to establish a geofence relative to the apparatus.

13. The apparatus of claim 12, wherein the controller activates a visual indicator when an authorized device enters the geofence.

14. The apparatus of claim 1, further comprising an exterior camera mounted to the housing.

15. A method for outdoor power supply and network connectivity, the method comprising:
removing an exterior light fixture from a junction box; and
mounting an apparatus over the junction box, wherein the apparatus comprises:
a housing having a front side and a rear side, the rear side mounted to the junction box and defining one or more openings for receiving wires from the junction box supplying main electrical power;
at least one power conversion module disposed within the housing for transforming the main electrical power; and
a wireless communication module disposed within the housing.

16. The method of claim 15, wherein one or more antennas associated with the wireless communication module are mounted to an outer side wall of the housing.

17. The method of claim 15, further comprising mounting a lighting element to the front side of the housing.

18. The method of claim 15, wherein the apparatus further comprises one or more power sockets positioned in a wall of the housing, the method further comprising connecting a plug to one of the one or more power sockets.

19. The method of claim 18, wherein the one or more power sockets comprise two to four power sockets, wherein a first power socket is connected to the main electrical power and a second power socket is connected to one of the at least one power conversion modules.

20. The method of claim 19, wherein the at least one power conversion module transforms a first voltage power supply into a second voltage power supply, wherein the first voltage differs from the second voltage.
